(19) United States
(12) Patent Application Publication
(10) Pub. No.: US 2011/0055276 A1
(43) Pub. Date: Mar. 3, 2011

(54) SYSTEMS AND METHODS FOR AUTOMATIC INCLUSION OF ENTITIES INTO MANAGEMENT RESOURCE GROUPS

(75) Inventors: DAVID B. HAMILTON, MILPITAS, CA (US); SANTHOSHKUMAR KOLATHUR, BANGALORE (IN)

(73) Assignee: BROCADE COMMUNICATIONS SYSTEMS, INC., SAN JOSE, CA (US)

(21) Appl. No.: 12/548,153

(22) Filed: Aug. 26, 2009

(51) Int. Cl. G06F 17/30

(52) U.S. Cl. 707/784; 707/E17.044

(57) ABSTRACT

Systems and methods for the automatic inclusion of entities into one or more management resource groups are described herein. Some embodiments include processing logic and memory coupled to the processing logic and including a database. The processing logic stores within the database a grouping representative of at least one network element, a role defined for a user, and a grouping-role pair associated with the user. The processing logic further automatically adds a new element as a grouping member upon its identification and automatically authorizes the user to perform the role with the new network element.

### BACKGROUND

As computer networks have continued to increase in complexity, so has the task of monitoring, configuring and maintaining such networks. It is not unusual for contemporary networks to include hundreds if not thousands of nodes that are interconnected by a similarly large number of network infrastructure devices such as switches, bridges and routers, all of which must be managed by IT personnel charged with operating the network at the highest possible level of reliability and availability. To assist IT personnel with managing large complex networks, software tools have been developed to simplify such network management by centralizing on a single workstation, or a small set of workstations, the information necessary to manage both hardware and software elements operating on the network. To further simplify the task of managing large numbers of network elements, most if not all network management tools are designed to operate on groupings of elements that are collectively referenced by a number of different terms (e.g., domains, sub-networks and resource groups). Such groupings allow users of the network management tool to be assigned access permissions applicable to entire groups, thus avoiding the need to assign such permissions for each individual element within a group (e.g., providing a user with write access to a storage area network (SAN) fabric, rather than write access to each individual switch within the SAN).

Nonetheless, with existing network management solutions, when a manageable element such as a new switch is added to a managed network IT personnel must manually add each new element to the management group before the element is visible and controllable by most if not all responsible personnel. For example, when a network device is added to a network within a Microsoft® Windows domain, the device must be added to the domain before it can be accessed and/or managed. For large dynamic networks, such manual additions of network elements to a management group can introduce significant delays between when new hardware and/or software elements are installed and when such new elements are available for use and visible to the network management software. Even if the new elements are available for use immediately, the lack of visibility to network managers may create unacceptable reliability and security risks, since failures and/or security breaches involving the new elements may not be visible to, or controllable by, personnel responsible for the particular group to which the new elements are assigned until the new element is added to the management group. Further, large numbers of manual additions and/or modifications to a network management configuration database increase the risk of misconfigurations due to human error.

### SUMMARY

Systems and methods for the automatic inclusion of entities into one or more management resource groups are described herein. At least some example embodiments include processing logic and memory coupled to the processing logic and including a database. The processing logic stores within the database a grouping representative of at least one network element, a role defined for a user, and a grouping-role pair associated with the user. The processing logic further automatically adds a new network element as a member of the grouping upon the identification of the new network element and automatically authorizes the user to perform the role with such new network element.

Other example embodiments include a method that includes storing within a database a grouping representing at least one network element, storing within the database a role defined for a user, and storing within the database a grouping-role pair associated with the user. The method further includes adding automatically a new network element as a member of the grouping in response to identifying the new network element and automatically authorizing the user to perform the role with such new network element without a user performing authorization operations.

Still other example embodiments include a networking system that includes one or more networks including at least one network element, one or more nodes coupled to the at least one network element, and a network management station coupled to the at least one network element. The network management station includes processing logic, memory coupled to the processing logic and including a database, and a network interface coupled to the processing logic and to the at least one network element. The processing logic stores within the database a grouping representative of at least some of the at least one network element, a role defined for a user, and a grouping-role pair associated with the user that authorizes the user to perform the role with the at least some of the at least one network element. The processing logic further detects an addition of a new network element to the at least one network element, automatically adds the new network element as a member of the grouping upon detection of the addition of the new network element, and automatically authorizes the user to perform the role with such new network element without authorization operations being performed by a user.

Yet other example embodiments include a computer-readable medium that includes software executable on a processor that causes the processor to store within a database a grouping representative of at least one network element, a role defined for a user, and a grouping-role pair associated with the user. The software further causes the processor to automatically add a new network element as a member of the grouping in response to the identification of the new network element and to automatically authorize the user to perform the role with such new network element without authorization operations being performed by a user.

### BRIEF DESCRIPTION OF THE DRAWINGS

For a detailed description of at least some example embodiments, reference will now be made to the accompanying drawings in which:

FIG. 1 illustrates a Fibre Channel SAN fabric that is managed by a network management station, and the addition of a switch to the SAN fabric that results in the automatic addition of the switch to a resource group, in accordance with at least some example embodiments;

FIG. 2A illustrates a method for associating a user role with a resource group, in accordance with at least some example embodiments;

FIGS. 2B, 2C and 2D illustrate examples of system management user interfaces for defining resource groups and roles, and for associating resource groups and roles with users, in accordance with at least some embodiments;

FIG. 3 illustrates a method for automatically adding a switch to a corresponding resource group in response to the addition of the switch to a network, in accordance with at least some example embodiments;

FIG. 4 illustrates the addition of a switch to an Ethernet network and the automatic addition of the switch to a corresponding resource group, in accordance with at least some example embodiments; and

FIGS. 5A and 5B illustrate an example of a computer system suitable for use as a network management station, in accordance with at least some example embodiments.

### DETAILED DESCRIPTION

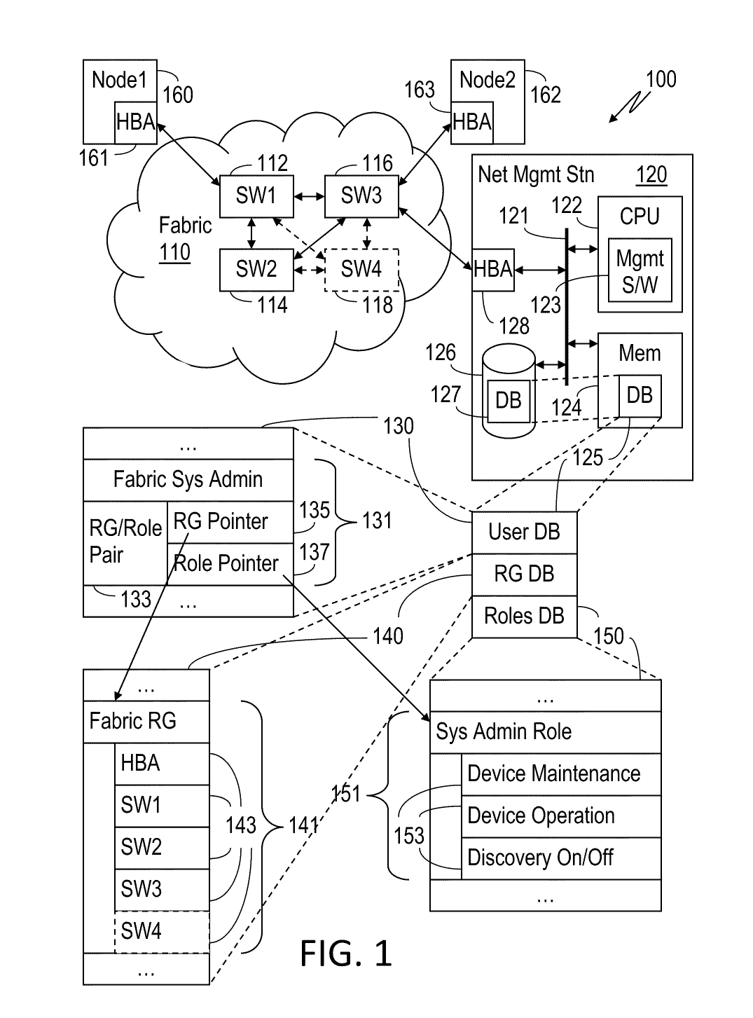

Referring to the storage area network (SAN) 100 of FIG. 1, a Fibre Channel SAN (FC-SAN) fabric 110 is shown that includes Fibre Channel switches SW1 112, SW2 114 and SW3 116 (prior to the addition of switch SW4 118). These switches provide connectivity between the various nodes connected to SAN fabric 110, such as nodel 160, node2 162 and network management station (Net Mgmt Stn) 120, through their respective host bus adapters (HBAs) 161, 162 and 128. In addition, there may also be a parallel management LAN (not shown), with each switch SW1 112, SW2 114 and SW3 116 and the management station 120 being connected to the management LAN to allow out-of-band management. Each of the switches and host bus adapters together represent the infrastructure that defines network 100 and its capabilities. In order to optimally, reliably and securely operate such a network, each of the devices must be carefully configured and continually monitored, a capability provided by network management station 120, in accordance with at least some example embodiments. Network management station 120 includes CPU 122, memory 124 and hard disk 126, which are each coupled to each other and network interface controller 128 via bus 121. A non-volatile copy 127 of the network management database is maintained on hard disk 126, while a working copy 125 of the database is maintained within memory 124. Management software 123 executes on CPU 122, and operates on database copy 125 within memory 124. Updates to memory-resident database copy 125 are also applied to database copy 127 on hard disk 126.

In at least some example embodiments, network management station 120 monitors and controls each of the devices of network 100 by communicating with each device directly. For example, if a management LAN is present, network management station 120 can retrieve configuration and status information from the devices, and issue commands to configure and control the devices, using messages that conform to the simple network management protocol (SNMP) or a proprietary protocol or API used by the switches, among others. In other example embodiments, network management station 120 monitors and controls the devices of network 100 by communicating with a management service provided by the network. For example, if network 100 is a Fibre Channel storage area network (FC-SAN) fabric, one or more of the switches within the fabric may provide the management service.

As part of its network monitoring function, network management station 120 monitors topology changes to network 100. In at least some example embodiments, network management station 120 periodically scans the network to determine which devices are connected to, and active on, network 100. If the configuration revealed by the scan does not match the configuration currently stored within database 125, the difference(s) are flagged as a change and appropriate action is taken, as described in more detail below. In other example embodiments, network management station 120 is configured to receive event-driven notifications from the network (e.g., from a network-resident management service). When such notifications are received by network management station 120, appropriate action is taken to update the stored network topology in response to the notification (e.g., by executing an interrupt service routine upon detecting an interrupt signal generated in response to the notification). Those of ordinary skill in the art will recognize that the above-described mechanisms are just two of a wide variety of network discovery mechanisms, and all such network discovery mechanisms are contemplated by the present disclosure.

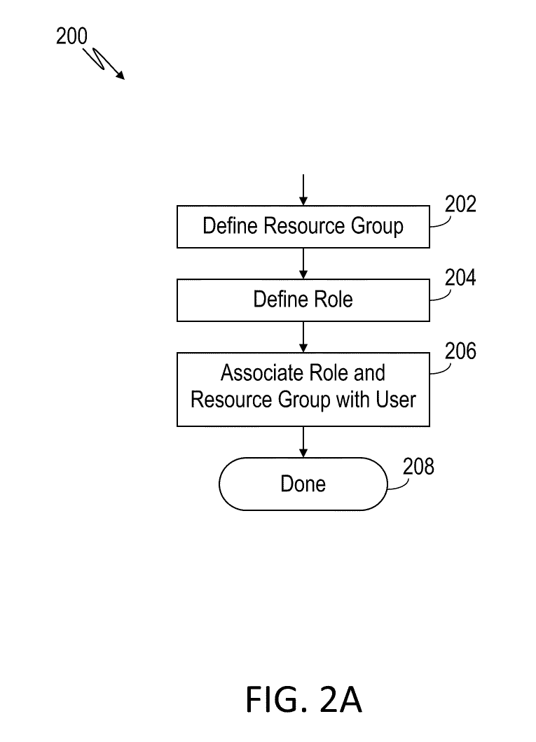

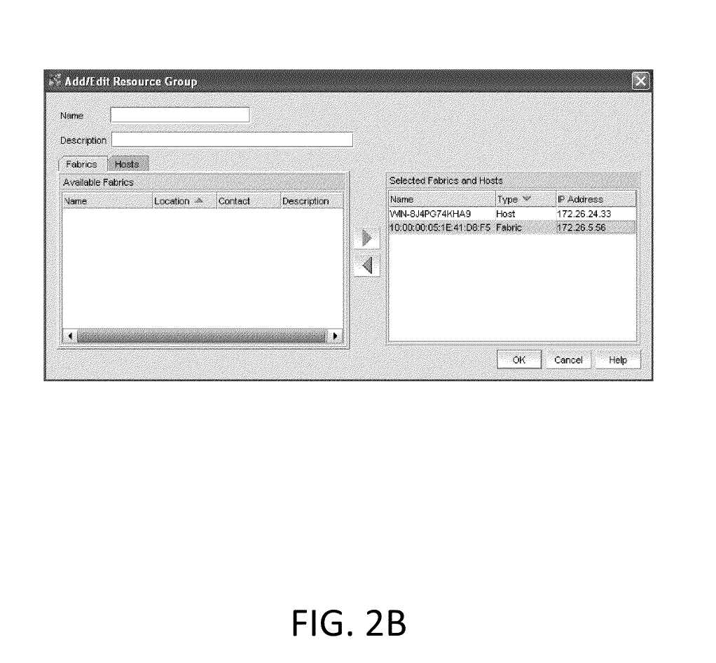

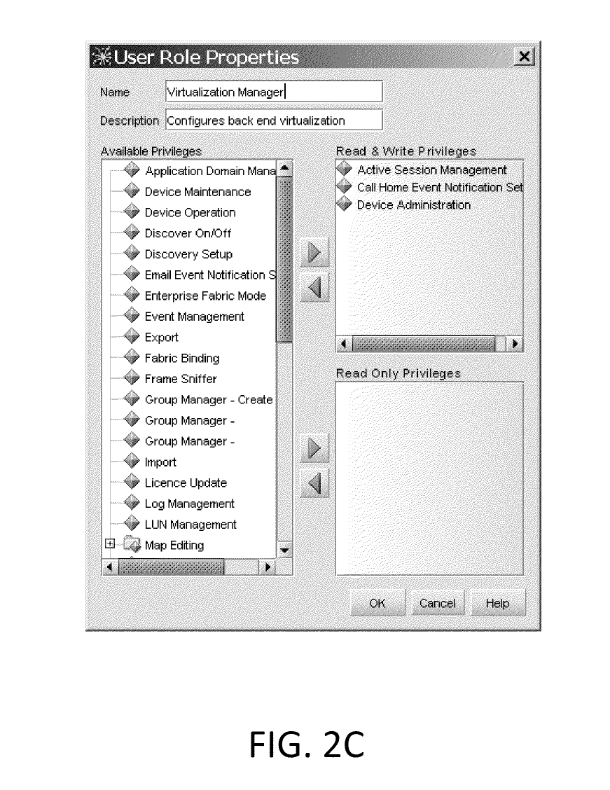

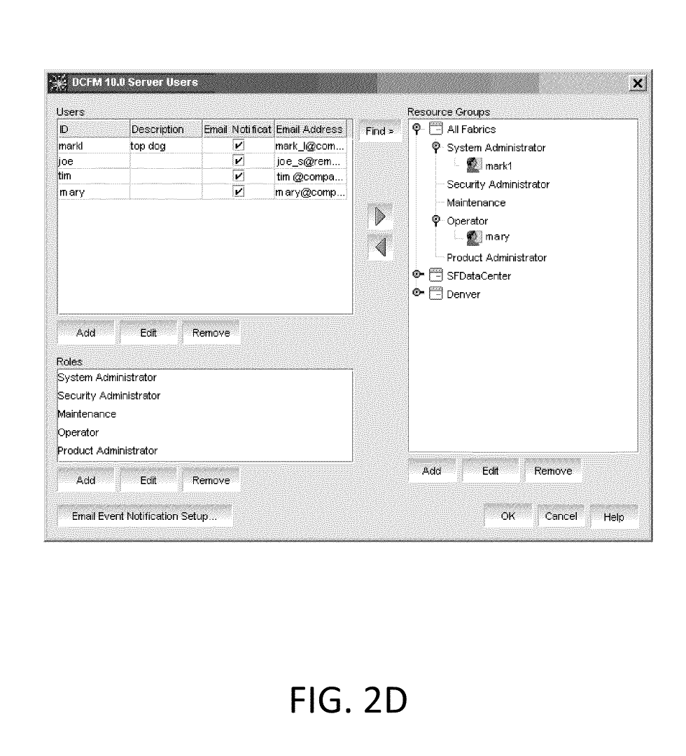

In at least some example embodiments, devices may be grouped together and managed as a single group. Referring to method 200 of FIG. 2A, these “resource groups” are defined (block 202). For example, if the SAN fabric 110 is defined as a resource group, the group includes network switches SWB1 (112), SWB2 (114) and SWB3 (116). When access to a resource group is granted to a user, the access granted applies to each device that is included within the resource group. Using this mechanism, different users can be assigned varying levels of access to the infrastructure devices of network 100 of FIG. 1 without having to assign access levels to each device individually. In the above-described example embodiment, the level of access granted is defined in terms of what function or “role” the user will have in monitoring, configuring, operating and/or maintaining network 100, and is thus referred to as a “role-based access control.” A given role is defined (block 204) in terms of the specific operations that a user assigned such a role is permitted to perform on a resource. For example, a system administrator role is created that defines the operations that a system administrator is permitted to perform on a network resource (e.g., configuring a device). The user who is system administrator for SAN fabric 110 is then assigned the role of system administrator for the fabric's resource group by associating the user ID defined for the fabric system administrator with the system administrator role under the SAN fabric 110 resource group (block 206). This enables the fabric system administrator to perform any authorized system administrator operation on any device included within the fabric resource group, ending method 200 of FIG. 2A (block 208). FIGS. 2B, 2C and 2D respectively illustrate examples of network management user interfaces for defining resource groups, for defining user roles, and for associating resource groups and user roles with a user.

Once a resource group is created and a user is assigned a role over the resource group, any resources subsequently added to the resource group are automatically accessible to the user, as defined by the role-based access controls applicable to the resource group for that user. In at least some example embodiments, the automatic application of a role to a resource added to a resource group is combined with the previously described topology monitoring, causing network management station 120 to automatically add to the resource group associated with a network or network segment a logical representation of any device added to the network or network segment. As a result, a network management station user authorized to perform a defined role with the resource group will automatically be authorized to perform the same role with any device added to such a network or network segment. The user is so authorized without the need for a person to perform at the network management station any action, manual configuration and/or authorization operation related to the addition of the device. Similarly, if a device is removed from the network, the device is also automatically deleted from membership with the corresponding resource group upon detection of the removal of the device, and the authorization of the user to perform the resource group role with the removed device is automatically revoked.

Referring again to FIG. 1, the fabric system administrator (Fabric Sys Admin) user is represented by user record 131 within user database (User DB) 130 of memory-resident database 125. Resource group/role pairs within user record 131 (e.g., RG/Role Pair 133) define what role a given user has relative to a resource group with pairs of pointers within user record 131. Thus, for example, resource group pointer (RG Pointer) 135 points to fabric resource group (Fabric RG) record 141 within resource group database (RG DB) 140, and role pointer 137 points to system administrator role (Sys Admin Role) record 151 within roles database (Roles DB) 150. The resource group and role database records each have fields that define the scope of the record. Fabric resource group record 141, for example, includes resource elements 143, while system administrator role record 151 includes privilege elements 153. Thus, in the example shown in FIG. 1, the fabric system administrator is authorized to execute commands (via, e.g., the network management station's user interface) related to device maintenance and operation of switches SW1, SW2 and SW3 (before the addition of switch SW4). The fabric system administrator is also authorized to turn on or off the fabric discovery function for fabric 110. Although the example shown only illustrates a single resource group/role pair, and a limited number of resources and privileges respectively associated with the user, resource group and role records, those of ordinary skill in the art will recognize that other embodiments may include records with any number of resource group/role pairs, any number of resources, and any number of privileges. Further, such embodiments may include records each having a scope that may overlap with the scope of other records within a given database. All such embodiments are contemplated by the present disclosure.

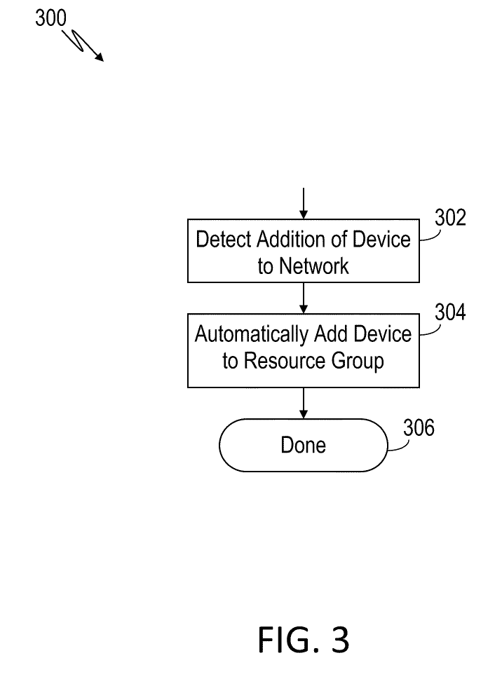

Referring now to both example storage area network 100 of FIG. 1 and example method 300 of FIG. 3, when FC-SAN switch SW4 (118) is added to fabric 110, the discovery mechanism implemented by network management station 120 detects the addition of the new switch (block 302 of method 300) and adds switch SW4 118 as an element of fabric resource group record 141 (block 304). This addition of SW4 118 to the fabric resource group record is performed automatically, and does not require any action or authorization by a network management station user providing information or input via a user interface. Thus, in the example shown, shortly after switch SW4 118 is physically attached to the fabric and powered up, the fabric system administrator corresponding to user database record 131 can begin to perform device maintenance and operation functions on switch SW4 118. This is due to the fact that the fabric system administrator has already been authorized to perform the aforementioned functions on the fabric resource group, and this authorization applies to all devices within the fabric resource group, which now includes switch SW4 118.

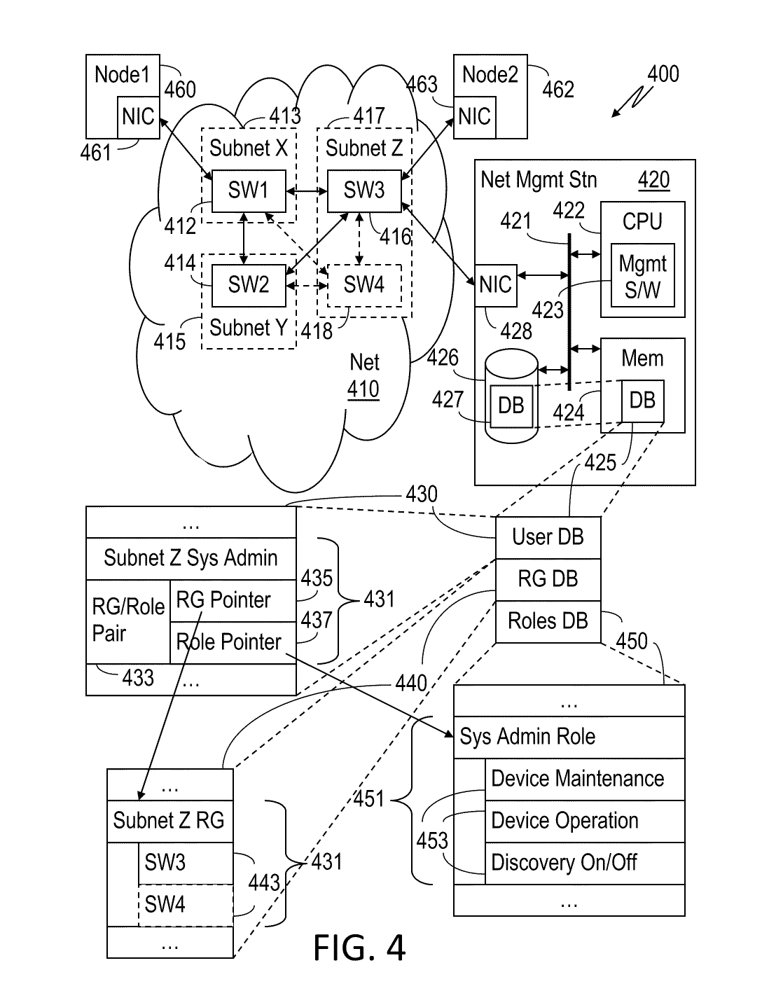

FIG. 4 shows an alternative embodiment that illustrates the automatic addition of an Ethernet switch to a resource group as a result of adding the switch to an Internet Protocol (IP) subnet within an Ethernet network. The network and database elements shown are similar to those shown in FIG. 1, and corresponding elements in each figure perform the same function (e.g., switch SW3 (114) of FIG. 1 and switch SW3 (414) of FIG. 4), or a similar function (e.g., HBA 128 of FIG. 1 and NIC 428 of FIG. 4). These functions are described in detail above and are not repeated here with regard to FIG. 4. Instead, only the differences are described. More specifically, in the example of FIG. 4 Ethernet network (Net) 410 is subdivided into subnets X, Y and Z. Subnet X (413) includes switch SW1 (412), subnet Y (415) includes switch SW2 (414), and subnet Z (417) prior to the addition of switch SW4 (418)) includes switch SW3 (416). Network interface controller 428 provides the interface to network 410 for network management station 420. Each subnet is defined as a resource group, with each switch within a given subnet defined as an element of the corresponding resource group record. The addition of switch SW4 (418) of FIG. 4 follows the same sequence as the example embodiment of FIG. 1. Example method 300 of FIG. 3 is also applicable to the example embodiment of FIG. 4. When the addition of switch SW4 (418) is detected, management station 420 recognizes from the address and network mask assigned to the switch that the newly added switch belongs to subnet Z, and as a result automatically adds switch SW4 (418) as a resource element 443 of subnet Z resource group record 431. As with the embodiment of FIG. 1, the addition of SW4 (418) to the subnet resource group record of FIG. 4 is performed automatically, and does not require any action or authorization by a network management station user providing information or input via a user interface. Once switch SW4 (418) is added to the resource group database record, the system administrator for subnet Z is automatically authorized to perform any function defined by system administrator role record 451 on the newly added switch. Subsequent removal of a switch from the subnet results in the automatic removal of that switch from the resource group and the automatic revocation of the user's authorization to perform the role over the removed switch in a manner similar to that already discussed with respect to the example of FIG. 3.

Although the examples of FIGS. 1 and 4 respectively illustrate a Fibre Channel SAN example and an Ethernet network example, those of ordinary skill in the art will recognize that the automatic application of a user role to a resource added to a network element represented by a resource group is not limited to the embodiments shown, and is applicable to a wide variety of networks, networking technologies, networking protocols and networking hardware and software elements. These include, but are not limited to: networks using other SAN technologies (e.g., InfiniBand); both wired and wireless networks; campus area network, metropolitan area networks, local area networks (e.g., Ethernet and Wi-Fi) and wide area networks (e.g., SONET, ATM, MPLS and frame relay); network devices such as switches, bridges, routers, firewalls, network interfaces (e.g., network interface controllers (NICs) and host bus adapters (HBAs)), and network access points (e.g., Wi-Fi wireless access points); and both physical and virtual variations of all of the above. All such networks, network technologies, networking protocols and network elements, and all combinations of such networks, network technologies, networking protocols and network elements (e.g., Fibre Channel over Ethernet), are contemplated by the present disclosure.

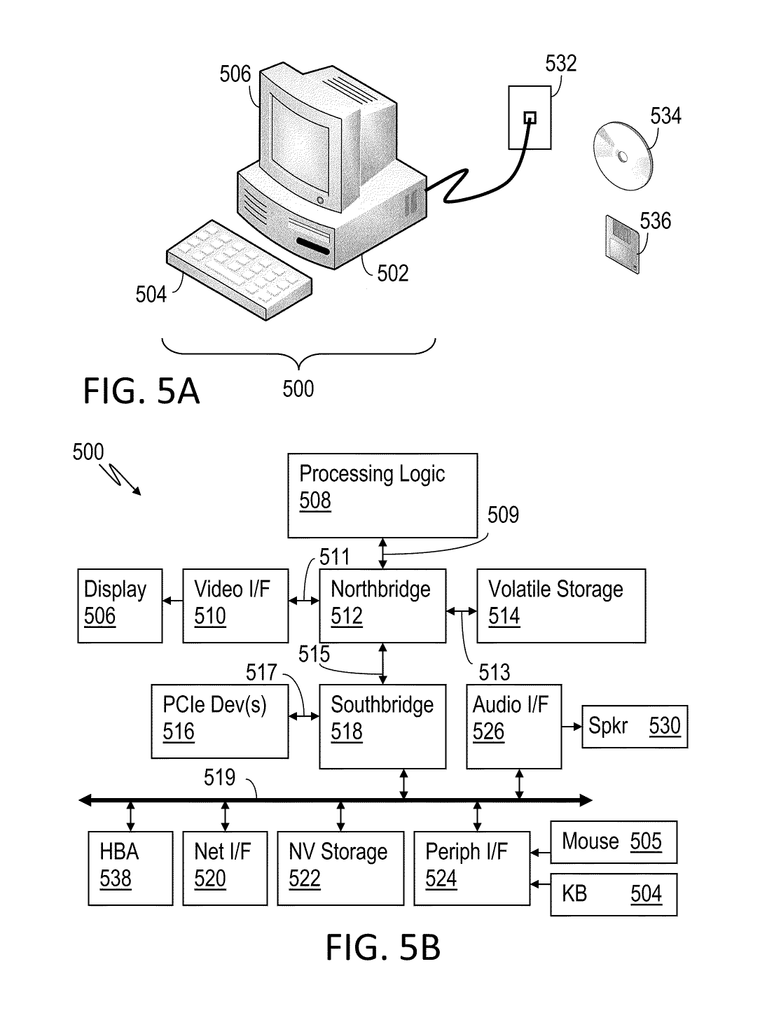

FIGS. 5A and 5B show a computer system suitable for implementing the networking management station embodiments described herein, (e.g., network management station 120 of FIG. 1). As shown, the computer system 500 includes a system unit 502, a keyboard 504 and a display 506. System unit 502 encloses processing logic 508, volatile storage 514 and non-volatile storage (NV Storage) 522. Processing logic 508 may be implemented in hardware (e.g., as one or more microprocessors that each may include one or more processor cores), in software (e.g., microcode), or as a combination of hardware and software. Volatile storage 514 may include a computer-readable storage medium such as random access memory (RAM). Non-volatile storage 522 may include a computer-readable medium such as flash RAM, read-only memory (ROM), electrically erasable programmable ROM (EEPROM), a hard disk, a floppy disk, (e.g., floppy disk 536), a compact disk ROM (i.e., CD-ROM, e.g., CD 534), and combinations thereof.

The computer-readable storage media of both volatile storage 514 and non-volatile storage 522 each includes software that may be executed by processing logic 508, and which provides computer system 500 with some or all of the functionality described in the present disclosure. Computer system 500 also includes a network interface, (Net I/F) 520, which enables computer system 500 to transmit and receive information via a network (e.g., a local area network), represented in the example of FIG. 5A by network jack 532. Network interface 520 may be a wireless interface (not shown), instead of the wired interface shown if FIG. 5A. Host bus adapter (HBA) 538 similarly enables computer system 500 to transmit and receive information via a storage area network (e.g., an FC-SAN). Video interface (Video I/F) 510 couples to display 506, and audio interface (Audio IF) 526 couples to Speaker (Spkr) 530. A user interacts with computer system 500 via keyboard (KB) 504 and mouse 505 (or alternatively, any similar data entry and/or pointing device), which each couples to peripheral interface (Periph I/F) 524. Display 506, together with keyboard 504 and/or mouse 505, operate together to provide the user interface hardware of computer system 500.

Computer system 500 may be a bus-based computer, with a variety of busses interconnecting the various elements shown in FIG. 5B through a series of hubs and/or bridges, including Northbridge 512 (sometimes referred to as a memory hub controller (MCH) or an integrated memory controller (IMC)) and Southbridge 518 (sometimes referred to as an I/O Controller Hub (ICH) or a Platform Controller Hub (PCH)). The busses of the example of FIG. 5B include: front-side bus 509 coupling processing logic 508 to Northbridge 512; graphics bus 511 (e.g., an accelerated graphics port (AGP) bus or a peripheral component interface (PCI) express ×16 bus) coupling video interface 510 to Northbridge 512; PCI bus 519 coupling network interface 520, host bus adapter 538, non-volatile storage 522, peripheral interface 524, audio interface 526 and Southbridge 518 to each other; PCI express (PCIe) bus 517 coupling one or more PCI express devices (PCIe Dev(s)) 516 to Southbridge 518; bridge interconnect bus 515 (e.g., an Intel® Direct Media Interface (DMI)) coupling Northbridge 512 and Southbridge 518 to each other; and memory bus 513 coupling Northbridge 512 to volatile storage 514.

Peripheral interface 524 accepts signals from keyboard 504 and/or mouse 505 and transforms the signals into a form suitable for communication on PCI bus 519. Audio interface 526 similarly accepts signals from PCI bus 519 and transforms the signals into a form suitable for speaker 530. Video interface 510 (e.g., a PCIe graphics adapter) accepts signals from graphics bus 511 and transforms the signals into a form suitable for display 506. Processing logic 508 gathers information from other system elements, including input data from peripheral interface 524, and program instructions and other data from non-volatile storage 522 and volatile storage 514, or from other systems (e.g., a server used to store and distribute copies of executable code) coupled to a local or wide area network via network interface 520. Processing logic 508 executes the program instructions (e.g., management software 123 executing on CPU 122 of FIG. 1), and processes the data accordingly. The program instructions may further configure processing logic 508 to send data to other system elements, such as information presented to the user via video interface 510 and display 506 or via audio interface 526 and speaker 530. Network interface 520 enables processing logic 508 to communicate with other systems via a network (e.g., the Internet). Volatile storage 514 may operate as a low-latency repository of information for processing logic 508, while non-volatile storage 522 may operate as a long-term (but higher latency) repository of information (e.g., for storage of network management database 127 on non-volatile storage device (disk drive) 126 of FIG. 1).

Processing logic 508, and hence computer system 500 as a whole, operates in accordance with one or more programs stored on non-volatile storage 522, received via host bus adapter 538, or received via network interface 520. Processing logic 508 may copy portions of the programs into volatile storage 514 for faster access, and may switch between programs or carry out additional programs in response to user actuation of keyboard 504 and/or mouse 505. The additional programs may also be retrieved from non-volatile storage 522, or may be retrieved or received from other locations via either host bus adapter 538 or network interface 520. One or more of these programs execute on computer system 500, causing the computer system to perform at least some of the functions described herein.

Although the embodiments described include software executing on individual, self contained physical computers, software that implements the functionality described herein is not limited to such physical computers. Those of ordinary skill in the art will recognize that other implementations of a computer system may be suitable for executing software that implements at least some of the functionality herein (e.g., network management software 423 of FIG. 4). These may include virtualized computer systems (e.g., systems implemented using VMWare® Workstation software by VMware®), and distributed computer systems (e.g., diskless workstations and netbooks), just to name a few examples. All such implementations and variations of a computer system are contemplated by the present disclosure.

The above discussion is meant to illustrate the principles of at least some example embodiments. Other variations and modifications will become apparent to those of ordinary skill in the art once the above disclosure is fully appreciated. For example, although the resource groups of the example embodiments presented are defined based upon either a physical connection to a common fabric or based upon an assignment to a common subnet, any common attribute or combination of common attributes of a resource may be used to define which resources belong to a given resource group. Also, although the network management station functions are implemented in the embodiments as software executing on a central processing unit, other implementations may include network management stations with functions implemented using only hardware (e.g., using field programmable gate arrays or FPGAs). Further, resources are not limited to hardware resources, and at least some example embodiments include software resources that can be monitored, configured, controlled and maintained by the above-described network management station. It is intended that the following claims be interpreted to include all such variations and modifications.

What is claimed is:

1. A computer system, comprising:
processing logic; and
memory coupled to the processing logic and comprising a database;
wherein the processing logic:
stores within the database a grouping representative of at least one network element;
stores within the database a role defined for a user;
stores within the database a grouping-role pair associated with the user; and
automatically adds a new network element as a member of the grouping upon the connection of the new network element to the network and automatically authorizes the user to perform the role with such new network element.

2. The computer system of claim 1, wherein the grouping comprises logical representations of the network and of each of the at least one network element with the grouping.

3. The computer system of claim 2, wherein the logical representation of the network comprises a network selected from the group consisting of a campus area network, a metropolitan area network, a local area network, a wide area network, and a storage area network.

4. The computer system of claim 2, wherein the logical representation of the network comprises a network selected from the group consisting of a Fibre Channel network, an Infiniband network, an Ethernet network, a Wi-Fi network, an asynchronous transfer mode (ATM) network, a synchronous optical networking (SONET) network, a multiprotocol label switching (MPLS) network, and a frame relay network.

5. The computer system of claim 2, wherein at least some of the logical representations of the at least one network element each comprises a representation of a device selected from the group consisting of a network switch, a network router, a network bridge, a network firewall, a wireless access point and a network interface.

6. The computer system of claim 1, wherein the processing logic identifies the new network element as a physical hardware device addition to the at least one network element.

7. The computer system of claim 1, wherein the processing logic identifies the new network element as a virtual device addition to the at least one network element.

8. The computer system of claim 1, wherein the grouping comprises logical representations of network elements that share one or more common attributes.

9. The computer system of claim 8, wherein the one common attribute is being in a common storage area network fabric or a common Internet protocol (IP) subnet address range.

10. The computer system of claim 1, wherein the processing logic further identifies one of the at least one network element as removed from the at least one network element, automatically deletes the at least one removed network element from membership with the grouping upon such further identification, and automatically revokes the user's authorization to perform the role with the at least one removed network element.

11. A method, comprising:
storing within a database a grouping representing at least one network element;
storing within the database a role defined for a user;
storing within the database a grouping-role pair associated with the user; and
adding automatically a new network element as a member of the grouping in response to identifying the new network element and automatically authorizing the user to perform the role with such new network element without a user performing authorizing operations.

12. The method of claim 11, further comprising identifying the new network element as an addition to the at least one network element.

13. The method of claim 11, wherein the grouping comprises logical representations of a network and of each of the at least one network element.

14. The method of claim 13, wherein the logical representation of the network comprises a network selected from the group consisting of a campus area network, a metropolitan area network, a local area network, a wide area network, and a storage area network.

15. The method of claim 13, wherein the logical representation of the network comprises a network selected from the group consisting of a Fibre Channel network, an Infiniband network, an Ethernet network, a Wi-Fi network, an asynchronous transfer mode (ATM) network, a synchronous optical networking (SONET) network, a multiprotocol label switching (MPLS) network, and a frame relay network.

16. The method of claim 13, wherein at least some of the logical representations of the at least one network element each comprises a representation of a device selected from the group consisting of a network switch, a network router, a network bridge, a network firewall, a wireless access point and a network interface.

17. The method of claim 11, wherein the identifying comprises identifying the new network element as a physical hardware device addition to the at least one network element.

18. The method of claim 11, wherein the identifying comprises identifying the new network element as a virtual device addition to the at least one network element.

19. The method of claim 11, wherein the grouping comprises network elements that share one or more common attributes.

20. The method of claim 19, wherein the one common attribute is being in a common storage area network fabric or a common Internet Protocol (IP) subnet address range.

21. The method of claim 11, further comprising:
further identifying one of the at least one network element as removed from the at least one network element;
deleting automatically the at least one removed network element from membership with the grouping upon such further identifying; and
revoking automatically the user's authorization to perform the role with the at least one removed network element without the user performing authorizing operations.

22. A computer-readable medium comprising software that can be executed on a processor to cause the processor to:
store within a database a grouping representative of at least one network element;
store within the database a role defined for a user;
store within the database a grouping-role pair associated with the user;
automatically add a new network element as a member of the grouping in response to identification of the new network element and automatically authorize the user to perform the role with such new network element without authorization operations being performed by a user.

23. The computer-readable medium of claim 22, wherein the software further causes the processor to identify a new network element as an addition to the at least one network element.

24. The computer-readable medium of claim 22, wherein the grouping comprises logical representations of a network and of each of the at least one network element with the grouping.

25. The computer-readable medium of claim 24, wherein the logical representation of the network comprises a network selected from the group consisting of a local area network, a campus area network, a metropolitan area network, a wide area network, and a storage area network.

26. The computer-readable medium of claim 24, wherein the logical representation of the network comprises a network selected from the group consisting of a Fibre Channel network, an Infiniband network, an Ethernet network, a Wi-Fi network, an asynchronous transfer mode (ATM) network, a synchronous optical networking (SONET) network, a multiprotocol label switching (MPLS) network, and a frame relay network.

27. The computer-readable medium of claim 24, wherein at least some of the logical representations of the at least one network element each comprises a representation of a device selected from the group consisting of a network switch, a network router, a network bridge, a network firewall, a wireless access point and a network interface.

28. The computer-readable medium of claim 22, wherein the software further causes the processor to identify the new network element as a physical hardware device addition to the at least one network element.

29. The computer-readable medium of claim 22, wherein the software further causes the processor to identify the new network element as a virtual device addition to the at least one network element.

30. The computer-readable medium of claim 22, wherein the grouping comprises network elements that share one or more common attributes.

31. The computer-readable medium of claim 30, wherein the one common attribute is being in a common storage area network fabric or a common Internet Protocol (IP) subnet address range.

32. The computer-readable medium of claim 22, wherein the software further causes the processor to:
further identify one of the at least one network element as removed from the at least one network element;
delete automatically the at least one removed network element from membership with the grouping upon such further identification; and
revoke automatically the user's authorization to perform the role with the at least one removed network element without the user performing authorizing operations.
